(19) United States
(12) Patent Application Publication
(10) Pub. No.: US 2022/0342948 A1
(43) Pub. Date: Oct. 27, 2022

(54) APPARATUSES AND METHODS FOR FACILITATING SEARCHING BASED ON PROFILES AND OPTIONS

(71) Applicant: AT&T Intellectual Property I, L.P., Atlanta, GA (US)

(72) Inventors: Robert Koch, Norcross, GA (US); Nigel Bradley, Canton, GA (US); Rashmi Palamadai, Naperville, IL (US); Eric Zavesky, Austin, TX (US); Ari Craine, Marietta, GA (US)

(73) Assignee: AT&T Intellectual Property I, L.P., Atlanta, GA (US)

(21) Appl. No.: 17/238,277

(22) Filed: Apr. 23, 2021

(51) Int. Cl. G06F 16/9535; G06F 16/951; G06F 16/9538; G06Q 30/02; G10L 15/26

(52) U.S. Cl. CPC G06F 16/9535; G06F 16/951; G06F 16/9538; G06Q 30/0256; G10L 15/26

(57) ABSTRACT

Aspects of the subject disclosure may include, for example, identifying a first communication device associated with a first user, identifying, based on the identifying of the first communication device associated with the first user, at least one profile, wherein the at least one profile is associated with the first user, a second user that is different from the first user, or a combination thereof, providing at least one option to the first communication device based on an analysis of data included in the at least one profile, receiving a selection of a first option included in the at least one option, performing a search for content based on the receiving of the selection of the first option, generating search results based on the search, and providing the search results to the first communication device. Other embodiments are disclosed.

### FIELD OF THE DISCLOSURE

The subject disclosure relates to apparatuses and methods for facilitating searching based on profiles and options.

### BACKGROUND

As the world becomes increasingly connected through vast communication systems and networks and via various communication devices, additional opportunities are generated to provision content to users of such systems, networks, and devices. However, it is often difficult for a user to pinpoint content that is relevant to the user's particular interests or needs at a given point in time, given the large amount/volume of content that is now available. In this respect, the user will frequently engage in a manual, iterative search process, whereby a first search generates first search results, and the first search results are subject to additional search/filtration to generate second search results that are subsumed within the first search results. The process of searching-the-search-results of a prior step is repeated until relevant search results are identified or the user gives up/quits in frustration.

As the foregoing discussion demonstrates, the process of arriving at relevant search results/content is time-consuming and frustrating. Moreover, the process of arriving at relevant search results is prone to error, as the quality of the search results is highly dependent on the search criteria that is entered by the user in the first instance. In the absence of preexisting knowledge or guidance, the quality of the search results is largely left to chance based on the criteria that the user provides.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 for facilitating online activities in accordance with various aspects described herein.

FIG. 2B depicts an example, non-limiting embodiment of search results in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for obtaining guidance in respect of a search for content and a provisioning of content based on a use of profiles. Other embodiments are described in the subject disclosure.

One or more aspects of the subject disclosure include, in whole or in part, obtaining a search request from a first user equipment associated with a first user, responsive to the obtaining of the search request, performing a search to obtain search results, applying data of at least one profile to the search results, the applying resulting in a generation of a plurality of search options, providing a first indication of the plurality of search options to the first user equipment, obtaining, based on the providing of the first indication, a second indication of a first selection of at least one search option included in the plurality of search options from the first user equipment, filtering, based on the obtaining of the second indication, the search results based on the at least one search option, resulting in filtered search results, and providing the filtered search results to the first user equipment.

One or more aspects of the subject disclosure include, in whole or in part, providing a first indication of a plurality of options to a first communication device, receiving, from the first communication device and based on the providing of the first indication, a second indication of a selection of at least one option included in the plurality of options, identifying, based on the receiving of the second indication, at least one content item to provide to the first communication device, wherein the at least one content item is included in a plurality of content items, and wherein the plurality of content items is determined based on criteria specified by the first communication device, and transmitting, based on the identifying of the at least one content item, the at least one content item to the first communication device.

One or more aspects of the subject disclosure include, in whole or in part, identifying a first communication device associated with a first user, identifying, based on the identifying of the first communication device associated with the first user, at least one profile, wherein the at least one profile is associated with the first user, a second user that is different from the first user, or a combination thereof, providing at least one option to the first communication device based on an analysis of data included in the at least one profile, receiving a selection of a first option included in the at least one option, performing a search for content based on the receiving of the selection of the first option, generating search results based on the search, and providing the search results to the first communication device.

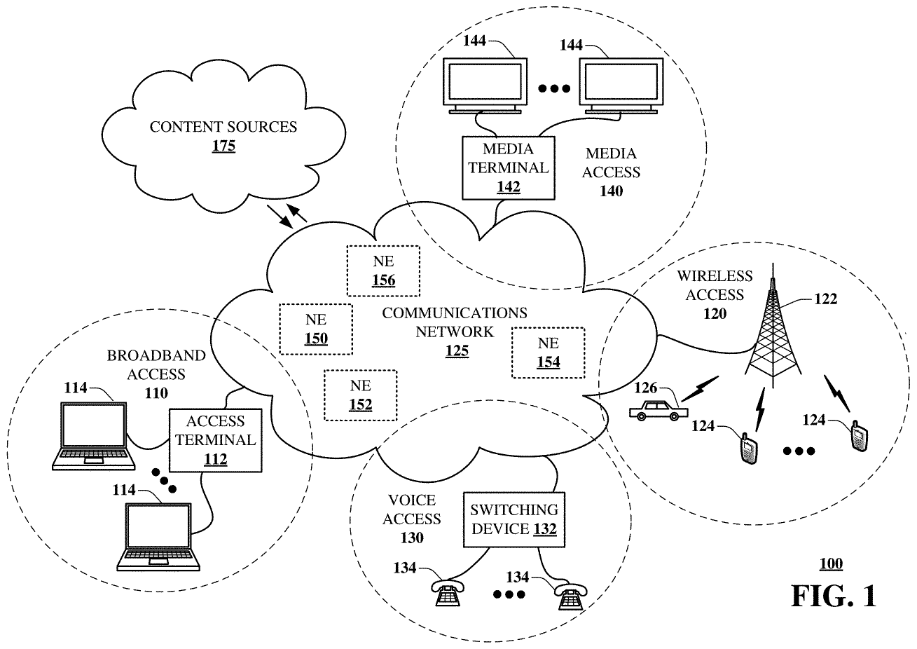

Referring now to FIG. 1, a block diagram is shown illustrating an example, non-limiting embodiment of a system 100 in accordance with various aspects described herein. For example, system 100 can facilitate in whole or in part obtaining a search request from a first user equipment associated with a first user, responsive to the obtaining of the search request, performing a search to obtain search results, applying data of at least one profile to the search results, the applying resulting in a generation of a plurality of search options, providing a first indication of the plurality of search options to the first user equipment, obtaining, based on the providing of the first indication, a second indication of a first selection of at least one search option included in the plurality of search options from the first user equipment, filtering, based on the obtaining of the second indication, the search results based on the at least one search option, resulting in filtered search results, and providing the filtered search results to the first user equipment. System 100 can facilitate in whole or in part providing a first indication of a plurality of options to a first communication device, receiving, from the first communication device and based on the providing of the first indication, a second indication of a selection of at least one option included in the plurality of options, identifying, based on the receiving of the second indication, at least one content item to provide to the first communication device, wherein the at least one content item is included in a plurality of content items, and wherein the plurality of content items is determined based on criteria specified by the first communication device, and transmitting, based on the identifying of the at least one content item, the at least one content item to the first communication device. System 100 can facilitate in whole or in part identifying a first communication device associated with a first user, identifying, based on the identifying of the first communication device associated with the first user, at least one profile, wherein the at least one profile is associated with the first user, a second user that is different from the first user, or a combination thereof, providing at least one option to the first communication device based on an analysis of data included in the at least one profile, receiving a selection of a first option included in the at least one option, performing a search for content based on the receiving of the selection of the first option, generating search results based on the search, and providing the search results to the first communication device.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

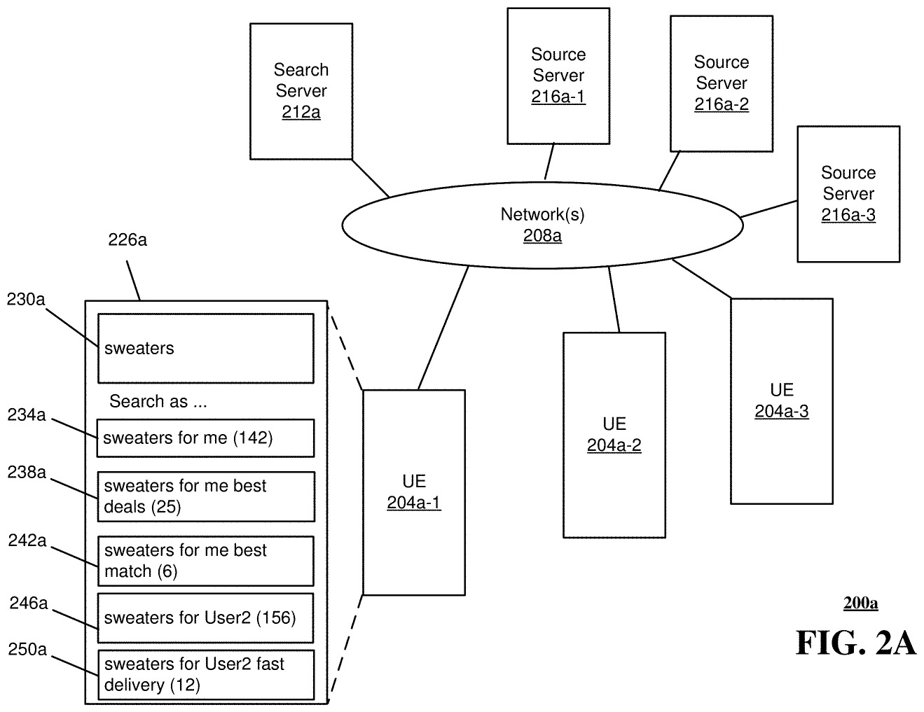

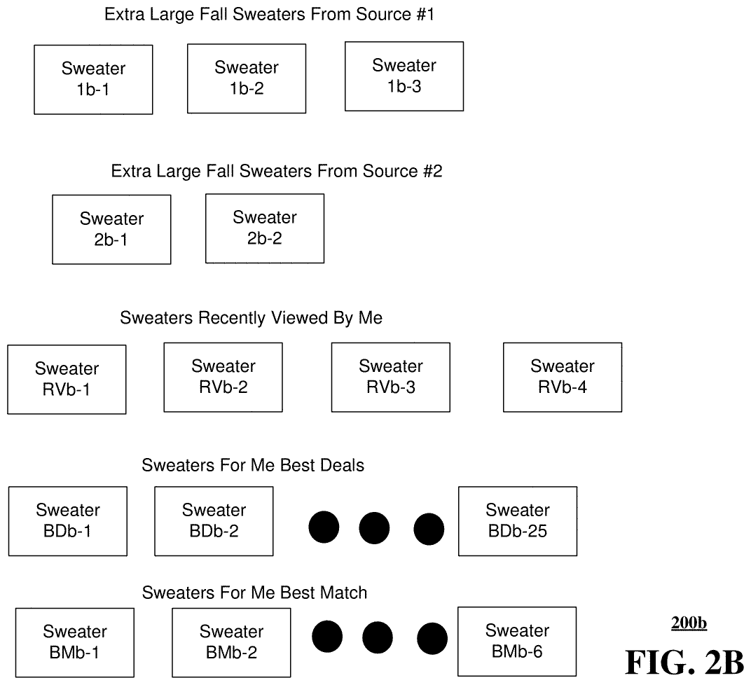

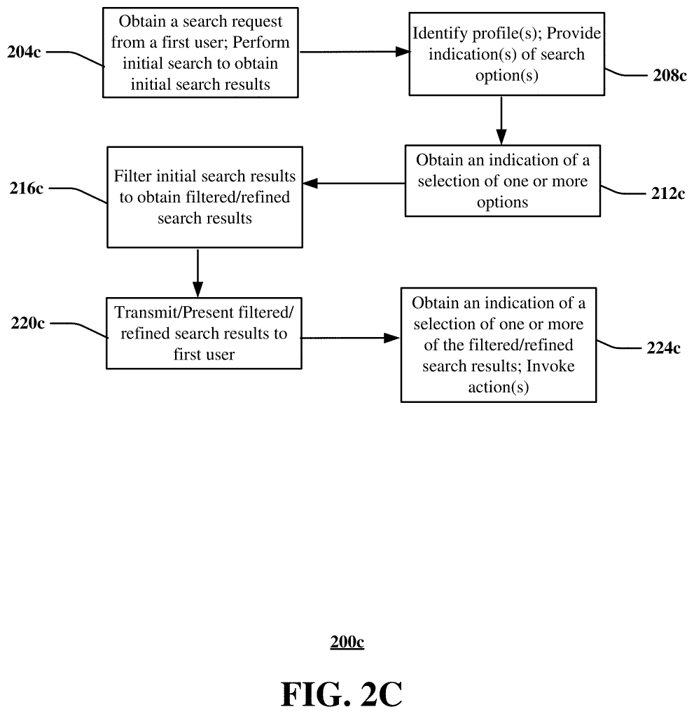

Referring now to FIG. 2A, a block diagram is shown illustrating an example, non-limiting embodiment of a system 200a. The system 200a may function within, or may be operatively overlaid upon, the communication network 100 of FIG. 1 in accordance with various aspects described herein. The system 200a may include one or more communication devices. For example, the system 200a may include a first user equipment (UE) 204a-1, a second UE 204a-2, and a third UE 204a-3. Each of the UEs 204a-1 through 204a-3 may be associated with a respective/different user; e.g., the first UE 204a-1 may be associated with a first user, the second UE 204a-2 may be associated with a second user, and the third UE 204a-3 may be associated with a third user.

The UEs 204a-1 through 204a-3 may be communicatively coupled to one another via one or more networks 208a. The network(s) 208a may adhere to one or more communication protocols or standards. In some embodiments, the network(s) 208a may utilize one or more radio access technologies (RATs). The network(s) 208a may be communicatively coupled to a search server 212a and one or more content source servers, such as for example a first source server 216a-1, a second source server 216a-2, and a third source server 216a-3.

The number of devices/entities shown in FIG. 2A is illustrative. In some embodiments, more or fewer than the number of devices shown in FIG. 2A may be utilized without departing from the scope of this disclosure. Additional devices/entities not shown in FIG. 2A may be utilized/included in some embodiments.

Having just described the various structural devices/entities that may be included in various embodiments of the system 200a, functionality that may be supported/facilitated by the system 200a is set forth in further detail below.

In operation, the system 200a may be used to provide content/content items (or references to such content/content items, such as for example via the use of one or more pointers or links) from one or more of the source servers 216a-1 through 216a-3 to one or more of the UEs 204a-1 through 204a-3. In the specific example shown in FIG. 2A, the content/content items are being targeted/provisioned to the first UE 204a-1.

The first UE 204a-1 may include a user interface (UI) 226a (e.g., a display screen). The UI 226a may be utilized in relation to an execution of a shopping or e-commerce application. It is understood that shopping/e-commerce is one example of an application that may be facilitated by the system 200a. Other types of applications, such as for example a distribution of media or documents, a selection and distribution of advertising/advertisements, a facilitation of communication sessions, gaming (e.g., online gaming), travel, news reporting, etc., may be accommodated by the system 200a (e.g., by the UI 226a) in various embodiments.

The UI 226a may include a search box 230a that may enable the first user of the first UE 204a-1 to enter a search string or search query. To demonstrate, and returning to the example of an execution of an application accommodating shopping/e-commerce, the text string “sweaters” may have been entered into the search box 230a by the first user. The entry “sweaters” in the search box 230a may be facilitated using one or more input devices, such as for example a soft-keyboard of the first UE 204a-1. In some embodiments, the first UE 204a-1 may execute a speech-to-text algorithm that may receive a search request (e.g., a search string) orally from the first user, and translate the spoken speech to text via a natural language/linguistics processing algorithm. Thus, the first user may utter an expression such as: “My device. Search for sweaters.”, and the first UE 204a-1 may recognize that the first user desires a search to be performed for sweaters based on the expression. Based on the entry of the search query in the search box 230a, the search query may be provided to the search server 212a. In turn, the search server 212a may search the source servers 216a-1 through 216a-3 for content (e.g., sweaters in the specific example shown in the search box 230a) that fits/matches the search query within one or more thresholds.

Based on the entry of a search string/query (see search box 230a), the first user may be provided, potentially in conjunction with the UI 226a, with one or more options in terms of refining the search facilitated by the search server 212a described above. For example, the options may include: sweaters for me 234a, sweaters for me best deals 238a, sweaters for me best match 242a, sweaters for User2 246a, and sweaters for User2 fast delivery 250a.

Each of the options 234a-250a may be associated with one or more profiles that may be partially or wholly stored by and/or accessed from, e.g., the first UE 204a-1, the search server 212a, etc. For example, the option sweaters for me 234a may be based at least in part on a first profile of the first user of the first UE 204a-1. As the nomenclature implies, the option 234a may correspond to sweaters within the content returned by the source servers 216a-1 through 216a-3 that may match criteria that is particular to the first user of the first UE 204a-1. Thus, if the first user is large in physical stature, such that the first user typically wears sweaters that are extra large in size, an application of the option sweaters for me 234a may omit/exclude sweaters that are smaller than extra large, e.g., may omit/exclude sweaters that are small and medium in size. Size is one example of criteria that may be applied to sweaters using criteria/data specified in the first profile; other criteria (such as for example, material composition) may be utilized.

As shown in FIG. 2A, the option sweaters for me 234a is denoted with a tag/label “(142)”, which may indicate that one hundred forty-two results/sweaters returned from the source servers 216a-1 through 216a-3 fit/match the criteria particular to the first user. Similar remarks apply with respect to the other options 238a-250a; e.g., the option sweaters for me best deals 238a is denoted as including twenty-five results/sweaters that fit/match the criteria associated with that option.

The option sweaters for me best deals 238a may be based on a portion of the (results associated with the) option sweaters for me 234a. The option 238a may facilitate “bargain shopping”, whereby the first user may obtain the best-bang-for-the-buck in terms of trading-off quality and price. For example, the option 238a may correspond to the corpus of sweaters represented within/by the option 234a that enhances (e.g., maximizes) the ratio of quality to price. In the context of sweaters, quality may be represented by material construction/composition, durability, name-brand recognition/reputation, etc. More generally, quality in any given context may be determined/assessed based on one or more factors/conditions, user inputs, and the like.

The option sweaters for me best match 242a may be based on a portion of the (results associated with the) option sweaters for me 234a. The option 242a may facilitate “quick searching”, whereby the first user may be provided with sweaters that are the most likely to be of interest to the first user. For example, if the first profile associated with the first user indicates that the first user routinely purchases cashmere sweaters (e.g., 75% of the first user's sweater purchases over time have corresponded to cashmere sweaters), the option 242a may omit/exclude sweaters composed of other materials (e.g., wool, polyester, etc.).

The options 246a and 250a may be associated with the second user of the second UE 204a-2. The options 246a and 250a may be based at least in part on data of a second profile associated with the second user. The options 246a and 250a may be presented by/within, e.g., the UI 226a, based on the second user granting permission to utilize at least a portion of the second profile. In some embodiments, such permission may be granted to users of the system 200a at-large/universally, or may be granted to specific users (such as for example the first user of the first UE 204a-1). In some embodiments, the permission granted by the second user may be based on an identification of an application/environment at hand—e.g., the second user may grant access to portions of the second profile in relation to shopping/e-commerce applications, but may deny/restrict access to portions of the second profile in relation to an expression of second user's political views. As this example demonstrates, the system 200a may be able to leverage aspects of the second profile to facilitate shopping/e-commerce, while at the same time respecting the second user's right to privacy in respect of, e.g., the second user's political views/leanings.

In some embodiments, the options 246a and 250a may be presented as suggestions for use by the first user of the first UE 204a-1, potentially based on a determination that the second user is a contact of the first user on one or more platforms (such as for example a social media platform). To the extent that the second user has not previously granted permission as set forth above (or, to the extent that the permission previously granted by the second user has expired—such as in accordance with a timeout or other condition), an option may be presented/provided to the first user (potentially as part of the UI 226a) to invite/request the second user to grant permission to the first user to enable the first user to access one or more portions of the (data associated with the) second user's profile.

The option sweaters for User2 246a may filter the results/sweaters returned by, e.g., the source servers 216a-1 through 216a-3 to correspond to sweaters that match the criteria in the second profile associated with the second user. Thus, if the second user is petite in physical stature, such that the second user typically wears sweaters that are of size small, an application of the option 246a may omit/exclude sweaters that are larger than small, e.g., may omit/exclude sweaters that are medium, large, and extra large in size. Size is one example of criteria that may be applied; other criteria may be used.

The option sweaters for User2 fast delivery 250a may be based on a portion of the (results associated with the) option sweaters for User2 246a. For example, it may be the case that the second user's birthday is quickly approaching, and the first user may want to purchase a sweater for the second user as a gift. The first user may want the gift to arrive at the second user's residence or place of business/employment on or before the second user's birthday. Thus, an application of the option 250a may serve to filter the sweaters referenced by the option 246a in accordance with expedited shipping (e.g., shipping guaranteed within a threshold number of days).

As described above, each of the options 234a-250a may potentially be selectable by the first user from the UI 226a. In some embodiments, whether a particular option is available for selection by the first user from the UI 226a may be based on a payment of a subscription or licensing fee by the first user (or another user). In some embodiments, whether a particular option is available for selection by the first user may be based on privacy considerations/parameters. For example, and as described above, the second user of the second UE 204a-2 may opt/elect to allow her profile to be available to: the public at large, a close group of contacts/friends/buddies (such as the first user of the first UE 204a-1), etc. Still further, in some embodiments a given user (e.g., the second user) may opt/elect to have a first portion of her profile available for use (by, e.g., the pubic at large) and may opt/elect to have a second portion of her profile restricted to herself or a subset of users.

Data associated with a given profile/option may be based on activities engaged in by a user (or group of users) associated with the profile/option. For example, the data associated with/contained within the second profile associated with the second user may be based on: searches performed by the second user of the second UE 204a-2, purchase activities/transactions engaged in by the second user, online activities (e.g., browsing, communication sessions, social media activities, etc.) engaged in by the second user, media consumed or produced by the second user, responses submitted by the second user to questionnaires or surveys, etc. Portions of the data may be made available for use by others and/or may be partially, or even completely, restricted based on the considerations set forth above. For example, the second user may opt to make the portions of her profile associated with shopping publicly accessible, whereas the portions of her profile associated with her political views may be maintained in privacy/secrecy (and thus, might not be shared with other users).

Data associated with a given profile/option may be automatically generated based on an analysis of an aggregate number of searches performed by one or more users, such as for example an identified user associated with the given profile. In some embodiments, data associated with the given profile/option may be based on a manual entry and/or a batch process.

The selection of a given option within the UI 226a may serve to present additional criteria (beyond just the search string contained within the search box 230a) to the search server 212a in performing or refining a search. For example, a selection of one or more of the options 234a-250a may supplement the search string/criteria of the search box 230a with particulars/parameters that are unique/particular to the selected option(s). In this respect, search results that are returned to the first user may omit/exclude results (e.g., sweaters) that fall outside of the criteria associated with the selected option(s).

In some of the examples set forth above, size and material were parameters/criteria that were applied to the entered search string “sweaters” in generating search results for the first user. Size and material are illustrative of parameters/criteria that may be applied in some embodiments. Other types or kinds of parameters may be utilized, such as for example price, location, availability in stock, brand/label, convenience (e.g., considerations of whether the first user has a pre-existing account [e.g., an online account] with a given merchant/outlet/source), ratings/rankings/scores in terms of quality of product or timeliness in delivery, shipping considerations (e.g., whether free or reduced-price shipping is available), availability (or lack thereof) of curbside pickup, etc.

In some embodiments, each of the source servers 216a-1 through 216a-3 may be associated with a particular outlet/source of merchandise (in the example of FIG. 2A: sweaters). In this respect, the search server 212a may facilitate a front-end application/service that may aggregate results pertaining to the search query “sweaters” from each of the sources. In some embodiments, an operator of the search server 212a may be compensated by, e.g., one or more of the outlets/sources associated with the source servers 216a-1 through 216a-3 for facilitating the front-end application/service.

FIG. 2B illustrates an example of search results 200b that may be returned to the first user/the first UE 204a-1. The search results 200b may be based on a selection of one or more of the options 234a-250a in FIG. 2A. For example, the search results 200b may be based on a selection of the option 234a. The search results 200b may be presented as part of the UI 226a of FIG. 2A in some embodiments.

The search results 200b may be organized/arranged using one or more formats. For example, the search results 200b are shown as being arranged as one or more rows—specifically, five rows in the example of FIG. 2B. The number of search results included in the search results 200b may match the number of results included in the selected option(s); 142 in the case of a selection of the option 234a of FIG. 2A. In this regard, and for the sake of simplicity in illustration, it is noted that the search results 200b shown in FIG. 2B may correspond to a subset of (e.g., less than all) the search results associated with the option 234a; e.g., in actuality, there may be more search results than what is explicitly shown in FIG. 2B in accordance with a selection of the option 234a.

The first row of the search results 200b may be representative of extra large fall sweaters that are available from a first source (where the first source may correspond to the first source server 216a-1 of FIG. 2A), where the qualifier ‘fall’ may have been automatically inserted based on the time of year that the search was performed (e.g., if the search was performed in August in the New York, the search may be conditioned based on looking ahead to the next season). In this respect, the first row may include information (e.g., graphics, text, pricing information, previews, product reviews, etc.) associated with three sweaters represented by reference characters 1b-1, 1b-2, and 1b-3.

The second row of the search results 200b may be representative of extra large fall sweaters that are available from a second source (where the second source may correspond to the second source server 216a-2 of FIG. 2A). In this respect, the second row may include information (e.g., graphics, text, pricing information, previews, product reviews, etc.) associated with two sweaters represented by reference characters 2b-1 and 2b-2.

The third row of the search results 200b may be representative of sweaters recently viewed (RV) by me (where ‘me’ in this context may refer to the first user of the first UE 204a-1 in FIG. 2A). In this respect, the third row may include information (e.g., graphics, text, pricing information, previews, product reviews, etc.) associated with four sweaters represented by reference characters RVb-1, RVb-2, RVb-3, and RVb-4. It may be that the first user recently expressed interest in the sweaters RVb-1 through RVb-4 (e.g., expressed interest within a threshold number of days from a present search date), but for whatever reason opted not to purchase the sweaters RVb-1 through RVb-4 previously. Thus, the third row may represent “a second chance” to appeal to the first user; perhaps the first user wanted to think about/mull purchasing the sweaters RVb-1 through RVb-4 when the first user initially viewed information pertaining to them.

The fourth row of the search results 200b may be representative of sweaters corresponding to the best deals (BD) for the first user. In this respect, the fourth row may include information (e.g., graphics, text, pricing information, previews, product reviews, etc.) associated with sweaters represented by reference character BDb-1, BDb-2, . . . BDb-25. It is noted that the count (25) of best deal (BD) sweaters in the fourth row of the search results 200b matches the count of sweaters referenced by the option 238a of FIG. 2A. Stated differently, the fourth row of the search results 200b may correspond to the option 238a of FIG. 2A, where the option 238a may be subsumed within the option 234a of FIG. 2A.

The fifth row of the search results 200b may be representative of sweaters corresponding to the best match (BM) for the first user. In this respect, the fifth row may include information (e.g., graphics, text, pricing information, previews, product reviews, etc.) associated with sweaters represented by reference characters BMb-1, BMb-2, . . . BMb-6. It is noted that the count (6) of best match (BM) sweaters in the fifth row of the search results 200b matches the count of sweaters referenced by the option 242a of FIG. 2A. Stated differently, the fifth row of the search results 200b may correspond to the option 242a of FIG. 2A, where the option 242a may be subsumed within the option 234a of FIG. 2A.

In some embodiments, the presentation of the search results 200b may take the form of sponsored content, whereby a merchant, a distributor, or other party affiliated with a given sweater included in the search results 200b may compensate a network operator or service provider: for including the given sweater in the search results 200b, based on the first user selecting the given sweater from the search results 200b, based on a completion of a purchase transaction for the given sweater by the first user, etc. In some embodiments, a selection or purchase of a sweater included in the search results 200b by the first user may result in the second user being compensated, such as for example if the selected/purchased sweater was included in the search results 200b based on a profile of the second user. Compensation to the second user may take the form of monetary compensation, discounts on merchandise, an increased/enhanced score or rating applied to the profile of the second user, etc. In some embodiments, a selection or purchase of a sweater included in the search results 200b by the first user may result in a profile of the first user being updated/modified to account for the selection/purchase.

Referring now to FIG. 2C, an illustrative embodiment of a method 200c in accordance with various aspects described herein is shown. The method 200c may be facilitated, in whole or in part, by one or more systems, devices, and/or components, such as for example the systems, devices, and components set forth herein. As set forth in further detail below, operations/blocks of the method 200c may be used to provision content to a first user (or, analogously, a communication device of the first user).

In block 204c, a search request/query may be obtained from the first user. The search request may be based on an entry of a search string by the first user (see FIG. 2A: “sweaters” in search box 230a). As part of block 204, an initial search (of, e.g., the source servers 216a-1 through 216a-3 of FIG. 2A) may be performed/conducted based on the entered search string to generate/obtain initial search results.

In block 208c, one or more profiles associated with one or more users, or groups of users, may be identified. The profile(s) of block 208c may include a profile associated with the first user and/or other users. As part of block 208c, one or more of the profiles may be identified based on: a user associated with a given profile being a contact of the first user, a user associated with a given profile being followed by the first user, a user associated with a given profile opting to share her profile with other users (inclusive of the first user), etc.

As part of block 208c, the profile(s) that are identified may be translated/transformed into selectable options (see FIG. 2A: options 234a-250a). The options may be presented to the first user as part of block 208c.

In block 212c, an indication of a selection of one or more of the options of block 208c may be obtained.

In block 216c, the initial search results (of block 204c) may be refined/filtered based on the option(s) indicated as being selected as part of block 212c. Application of the refinement/filter as part of block 216c may result in a generation/obtainment of filtered/refined search results.

In block 220c, the filtered/refined search results (or content associated therewith) may be transmitted/provided to the first user. As part of block 220c, the filtered/refined search results (or the content associated therewith) may be presented to the first user.

In block 224c, an indication of a selection of at least one filtered/refined search result (or associated content) within the filtered/refined search results of blocks 216c and 220c may be obtained. Based on the indication of the selection obtained as part of block 224c, one or more actions may be invoked, such as for example updating one or more profiles, compensating one or more users, initiating an order for a product or service on behalf of the first user (or a second user), navigating to a website associated with the product or the service, presenting media or advertisements to the first user (or the second user), facilitating a meeting or a communication session for the first user (or on behalf of the first user), etc.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As set forth herein, aspects of this disclosure may utilize data/information associated with one or more profiles to identify relevant content that is targeted/provisioned to a user (e.g., a requesting user). In accordance with aspects of this disclosure, a first user may obtain guidance in respect of search results or content based on characteristics (e.g., preferences, activities, behaviors, habits, experiences, etc.) associated with the first user and/or one or more other users. Search results or content that is provided to the first user may be based on an emulation of characteristics of one or more other users.

Aspects of this disclosure may apply artificial intelligence and/or machine learning to identify content that is likely of relevance to an identified user (or group of users). Data or information that is contained in one or more profiles may be updated/modified based on an occurrence of one or more events or conditions. In this respect, aspects of this disclosure may be adaptive in nature and may tend to accommodate changes in style or preferences over time.

Relative to conventional technologies/techniques, aspects of this disclosure reduce the amount of time it takes for users to identify and obtain content, or search results, of interest. By pinpointing relevant content/search results in accordance with criteria specified in one or more profiles or options, irrelevant content or search results can quickly and easily be discarded/eliminated/ignored. Moreover, the use of such profiles or options can be done in such a way that a user might not need to be concerned with the details of how the profiles or options are being utilized or maintained. In this respect, the user may obtain benefits of this disclosure without any appreciable accompanying expense in terms of overhead or complexity. Aspects of this disclosure respect a user's right to privacy by ensuring that only those details that a user wishes to share become available to others.

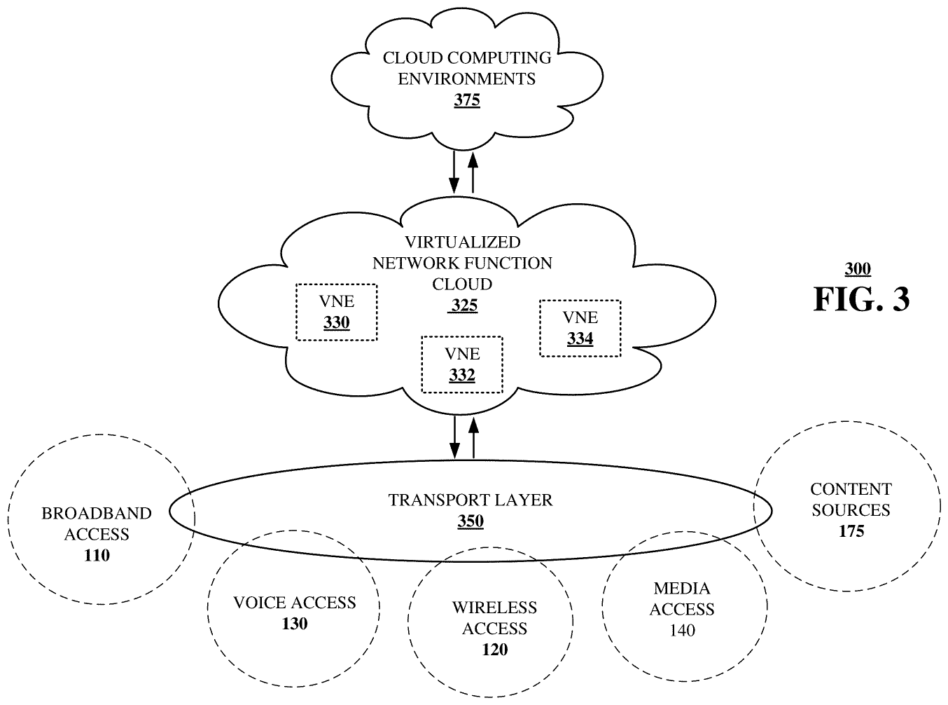

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200c presented in FIGS. 1, 2A, and 2C. For example, virtualized communication network 300 can facilitate in whole or in part obtaining a search request from a first user equipment associated with a first user, responsive to the obtaining of the search request, performing a search to obtain search results, applying data of at least one profile to the search results, the applying resulting in a generation of a plurality of search options, providing a first indication of the plurality of search options to the first user equipment, obtaining, based on the providing of the first indication, a second indication of a first selection of at least one search option included in the plurality of search options from the first user equipment, filtering, based on the obtaining of the second indication, the search results based on the at least one search option, resulting in filtered search results, and providing the filtered search results to the first user equipment. Virtualized communication network 300 can facilitate in whole or in part providing a first indication of a plurality of options to a first communication device, receiving, from the first communication device and based on the providing of the first indication, a second indication of a selection of at least one option included in the plurality of options, identifying, based on the receiving of the second indication, at least one content item to provide to the first communication device, wherein the at least one content item is included in a plurality of content items, and wherein the plurality of content items is determined based on criteria specified by the first communication device, and transmitting, based on the identifying of the at least one content item, the at least one content item to the first communication device. Virtualized communication network 300 can facilitate in whole or in part identifying a first communication device associated with a first user, identifying, based on the identifying of the first communication device associated with the first user, at least one profile, wherein the at least one profile is associated with the first user, a second user that is different from the first user, or a combination thereof, providing at least one option to the first communication device based on an analysis of data included in the at least one profile, receiving a selection of a first option included in the at least one option, performing a search for content based on the receiving of the selection of the first option, generating search results based on the search, and providing the search results to the first communication device.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

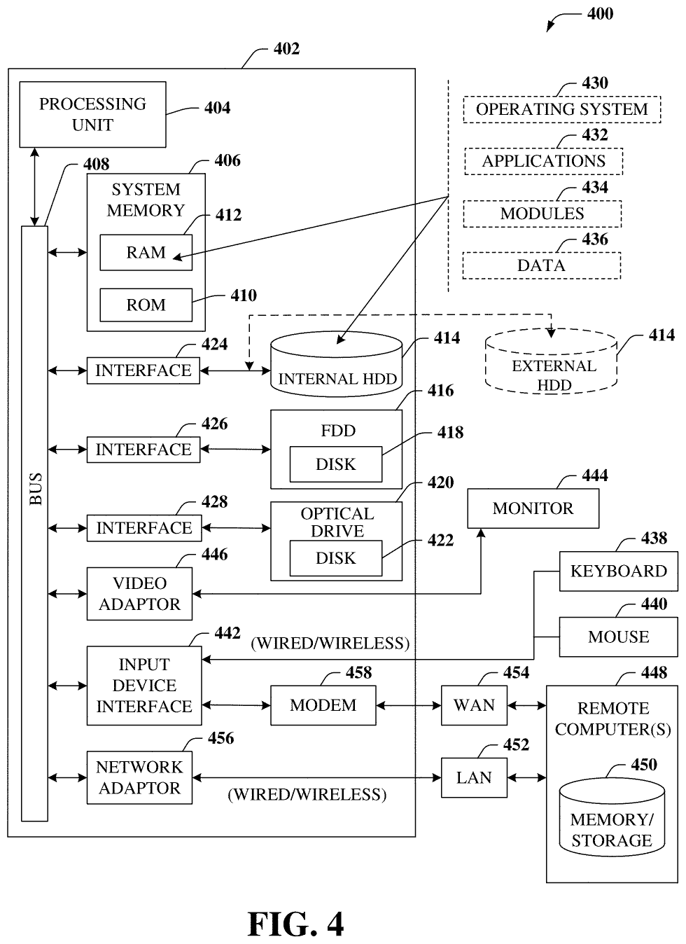

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part obtaining a search request from a first user equipment associated with a first user, responsive to the obtaining of the search request, performing a search to obtain search results, applying data of at least one profile to the search results, the applying resulting in a generation of a plurality of search options, providing a first indication of the plurality of search options to the first user equipment, obtaining, based on the providing of the first indication, a second indication of a first selection of at least one search option included in the plurality of search options from the first user equipment, filtering, based on the obtaining of the second indication, the search results based on the at least one search option, resulting in filtered search results, and providing the filtered search results to the first user equipment. Computing environment 400 can facilitate in whole or in part providing a first indication of a plurality of options to a first communication device, receiving, from the first communication device and based on the providing of the first indication, a second indication of a selection of at least one option included in the plurality of options, identifying, based on the receiving of the second indication, at least one content item to provide to the first communication device, wherein the at least one content item is included in a plurality of content items, and wherein the plurality of content items is determined based on criteria specified by the first communication device, and transmitting, based on the identifying of the at least one content item, the at least one content item to the first communication device. Computing environment 400 can facilitate in whole or in part identifying a first communication device associated with a first user, identifying, based on the identifying of the first communication device associated with the first user, at least one profile, wherein the at least one profile is associated with the first user, a second user that is different from the first user, or a combination thereof, providing at least one option to the first communication device based on an analysis of data included in the at least one profile, receiving a selection of a first option included in the at least one option, performing a search for content based on the receiving of the selection of the first option, generating search results based on the search, and providing the search results to the first communication device.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

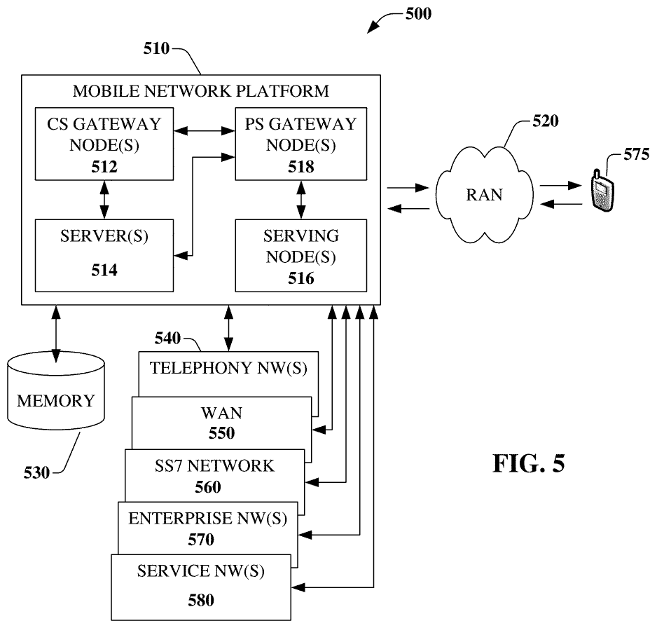

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part obtaining a search request from a first user equipment associated with a first user, responsive to the obtaining of the search request, performing a search to obtain search results, applying data of at least one profile to the search results, the applying resulting in a generation of a plurality of search options, providing a first indication of the plurality of search options to the first user equipment, obtaining, based on the providing of the first indication, a second indication of a first selection of at least one search option included in the plurality of search options from the first user equipment, filtering, based on the obtaining of the second indication, the search results based on the at least one search option, resulting in filtered search results, and providing the filtered search results to the first user equipment. Platform 510 can facilitate in whole or in part providing a first indication of a plurality of options to a first communication device, receiving, from the first communication device and based on the providing of the first indication, a second indication of a selection of at least one option included in the plurality of options, identifying, based on the receiving of the second indication, at least one content item to provide to the first communication device, wherein the at least one content item is included in a plurality of content items, and wherein the plurality of content items is determined based on criteria specified by the first communication device, and transmitting, based on the identifying of the at least one content item, the at least one content item to the first communication device. Platform 510 can facilitate in whole or in part identifying a first communication device associated with a first user, identifying, based on the identifying of the first communication device associated with the first user, at least one profile, wherein the at least one profile is associated with the first user, a second user that is different from the first user, or a combination thereof, providing at least one option to the first communication device based on an analysis of data included in the at least one profile, receiving a selection of a first option included in the at least one option, performing a search for content based on the receiving of the selection of the first option, generating search results based on the search, and providing the search results to the first communication device.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

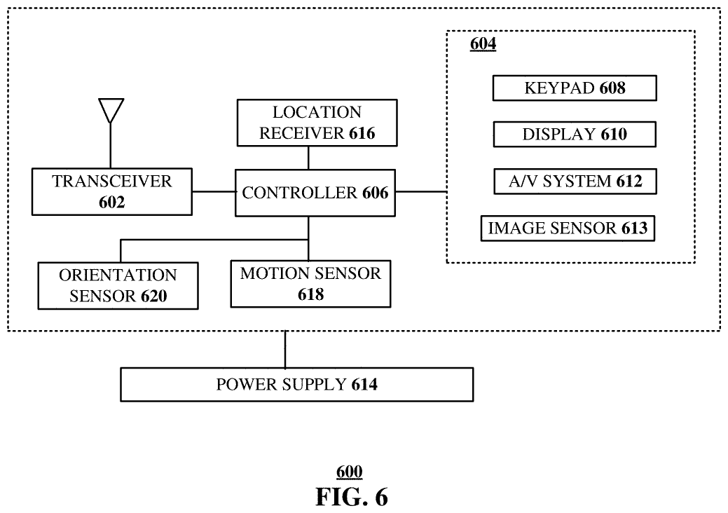

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part obtaining a search request from a first user equipment associated with a first user, responsive to the obtaining of the search request, performing a search to obtain search results, applying data of at least one profile to the search results, the applying resulting in a generation of a plurality of search options, providing a first indication of the plurality of search options to the first user equipment, obtaining, based on the providing of the first indication, a second indication of a first selection of at least one search option included in the plurality of search options from the first user equipment, filtering, based on the obtaining of the second indication, the search results based on the at least one search option, resulting in filtered search results, and providing the filtered search results to the first user equipment. Computing device 600 can facilitate in whole or in part providing a first indication of a plurality of options to a first communication device, receiving, from the first communication device and based on the providing of the first indication, a second indication of a selection of at least one option included in the plurality of options, identifying, based on the receiving of the second indication, at least one content item to provide to the first communication device, wherein the at least one content item is included in a plurality of content items, and wherein the plurality of content items is determined based on criteria specified by the first communication device, and transmitting, based on the identifying of the at least one content item, the at least one content item to the first communication device. Computing device 600 can facilitate in whole or in part identifying a first communication device associated with a first user, identifying, based on the identifying of the first communication device associated with the first user, at least one profile, wherein the at least one profile is associated with the first user, a second user that is different from the first user, or a combination thereof, providing at least one option to the first communication device based on an analysis of data included in the at least one profile, receiving a selection of a first option included in the at least one option, performing a search for content based on the receiving of the selection of the first option, generating search results based on the search, and providing the search results to the first communication device.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a search request from a first user equipment associated with a first user;
responsive to the obtaining of the search request, performing a search to obtain search results;
applying data of at least one profile to the search results, the applying resulting in a generation of a plurality of search options;
providing a first indication of the plurality of search options to the first user equipment;
obtaining, based on the providing of the first indication, a second indication of a first selection of at least one search option included in the plurality of search options from the first user equipment;
filtering, based on the obtaining of the second indication, the search results based on the at least one search option, resulting in filtered search results; and
providing the filtered search results to the first user equipment.

2. The device of claim 1, wherein the providing of the filtered search results to the first user equipment causes the first user equipment to present the filtered search results.

3. The device of claim 2, wherein the operations further comprise:
obtaining a third indication of a second selection of at least one filtered search result included in the filtered search results from the first user equipment; and
invoking an action based on the obtaining of the third indication of the second selection.

4. The device of claim 3, wherein the invoking of the action comprises: updating the data of the at least one profile, compensating at least one user associated with the at least one profile, initiating an order for a product or a service on behalf of the first user, navigating to a website associated with the product or the service, presenting media or advertisements to the first user, facilitating a meeting or a communication session for the first user via the first user equipment, or any combination thereof.

5. The device of claim 1, wherein the at least one profile comprises a first profile associated with the first user and a second profile associated with a second user.

6. The device of claim 5, wherein the operations further comprise:
identifying the second profile for inclusion in the at least one profile based on a determination that the second user is a contact of the first user on one or more platforms.

7. The device of claim 5, wherein the operations further comprise:
identifying the second profile for inclusion in the at least one profile based on a determination that the first user follows the second user on one or more platforms.

8. The device of claim 5, wherein the applying of the data of the at least one profile comprises obtaining first data included in the second profile to facilitate the generation of the plurality of search options.

9. The device of claim 8, wherein the second profile includes second data, and wherein the second data is not used in the generation of the plurality of search options based on the second user restricting access to the second data.

10. The device of claim 8, wherein the applying of the data of the at least one profile comprises obtaining second data included in the first profile to facilitate the generation of the plurality of search options.

11. The device of claim 1, wherein the filtered search results include an advertisement.

12. The device of claim 11, wherein the operations further comprise:
selecting the advertisement based on the data.

13. The device of claim 1, wherein the at least one profile comprises a first profile that is associated with a plurality of users.

14. The device of claim 13, wherein the plurality of users includes the first user.

15. A non-transitory machine-readable medium, comprising executable instructions that, when executed by a processing system including a processor, facilitate performance of operations, the operations comprising:
providing a first indication of a plurality of options to a first communication device;
receiving, from the first communication device and based on the providing of the first indication, a second indication of a selection of at least one option included in the plurality of options;
identifying, based on the receiving of the second indication, at least one content item to provide to the first communication device, wherein the at least one content item is included in a plurality of content items, and wherein the plurality of content items is determined based on criteria specified by the first communication device; and
transmitting, based on the identifying of the at least one content item, the at least one content item to the first communication device.

16. The non-transitory machine-readable medium of claim 15, wherein the first communication device is associated with a first user, and wherein the at least one option is associated with at least a second user that is different from the first user.

17. The non-transitory machine-readable medium of claim 15, wherein the operations further comprise:
receiving a search request from the first communication device, wherein the search request includes a search string; and
generating the criteria based on the search string.

18. The non-transitory machine-readable medium of claim 17, wherein the search request is received orally via a microphone of the first communication device, and wherein the operations further comprise:
translating the search request using a speech-to-text algorithm to generate a text string corresponding to the search string.

19. A method, comprising:
identifying, by a processing system including a processor, a first communication device associated with a first user;
identifying, by the processing system and based on the identifying of the first communication device associated with the first user, at least one profile, wherein the at least one profile is associated with the first user, a second user that is different from the first user, or a combination thereof;
providing, by the processing system, at least one option to the first communication device based on an analysis of data included in the at least one profile;
receiving, by the processing system, a selection of a first option included in the at least one option;
performing, by the processing system, a search for content based on the receiving of the selection of the first option;
generating, by the processing system, search results based on the search; and
providing, by the processing system, the search results to the first communication device.

20. The method of claim 19, wherein the at least one option includes a second option, the method further comprising:
receiving, by the processing system, a search request from the first communication device; and
performing, by the processing system and based on the receiving of the search request, a second search to generate initial search results, wherein the search results are included in the initial search results,
wherein the providing of the at least one option to the first communication device comprises providing a first indication of a first count of a first portion of the initial search results associated with the first option, and
wherein the providing of the at least one option to the first communication device comprises providing a second indication of a second count of a second portion of the initial search results associated with the second option.
